(19) United States
(12) Patent Application Publication
(10) Pub. No.: US 2015/0128740 A1
(43) Pub. Date: May 14, 2015

(54) Scissors Gear Device

(71) Applicants: Hiroyuki Hayashi, Osaka-shi (JP); Hideaki Segami, Higashimatsuyama-shi (JP)

(72) Inventors: Hiroyuki Hayashi, Osaka-shi (JP); Hideaki Segami, Higashimatsuyama-shi (JP)

(73) Assignee: Kabushiki Kaisha F.C.C., Hamamatsu-shi, Shizuoka (JP)

(21) Appl. No.: 14/400,550

(22) PCT Filed: Mar. 27, 2013
(86) PCT No.: PCT/JP2013/058927

§ 371 Date: Nov. 11, 2014

(30) Foreign Application Priority Data
May 11, 2012 (JP) 2012-110072

(51) Int. Cl. F16H 55/18

(52) U.S. Cl. CPC F16H 55/18
USPC 74/440

(57) ABSTRACT

Provided is a scissors gear device having a structure which is simplified so as to reduce its overall size and thereby expand the range of application and simplify its assembly process. A scissors gear device 100 includes a main gear 101 and a sub-gear 104. The main gear 101 has three curved-surface protrusions 102 formed at a peripheral edge of one side surface thereof. The curved-surface protrusions 102 are arranged in the circumferential direction and each have an arcuate shape. The sub-gear 104 has three sloped surfaces 105 formed at a peripheral edge of its side surface facing the main gear 101. The sloped surfaces 105 are arranged in the circumferential direction. The sloped surfaces 105 are provided at positions corresponding to the curved-surface protrusions 102 formed on the side surface of the main gear 101. Each sloped surface 105 is a flat surface which extends in the circumferential direction and slopes toward the interior of the sub-gear 104 at a predetermined angle θ. The sub-gear 104 is pressed against the main gear 101 by a spring 107. As a result, the sub-gear 104 rotates in the circumferential direction with respect to the main gear 101, whereby a phase difference is produced between the gears.

### TECHNICAL FIELD

The present invention relates to a scissors gear device in which a main gear and a sub-gear are disposed adjacent to each other and are rotatable relative to each other, and a load for causing the two gears to rotate in opposite directions is applied to the two gears to thereby produce a phase difference between them.

### BACKGROUND ART

A scissors gear device has been used in a clutch apparatus mounted on an automobile, a motorcycle, or the like. Such a scissors gear device is used in order to eliminate backlash between two gears which mesh with each other. In such a scissors gear device, in order to sandwich each tooth of one gear between two teeth of the other gear, the other gear is composed of two gears which are rotatable in opposite directions.

For example, below-listed Patent Document 1 discloses a scissors gear device provided in a centrifugal clutch apparatus. That scissors gear device includes a main gear and a sub-gear which are coaxially disposed and meshed with a gear formed on a clutch outer, and the sub-gear is always pressed against the gear formed on the clutch outer by means of the elastic force of a torsion spring. Also, below-listed Patent Document 2 discloses a scissors gear device provided in a speed reduction apparatus. In this scissors gear device, a primary drive gear and a scissors gear which are coaxially disposed are in meshing engagement with a primary driven gear, and three coil springs are disposed in a region where the primary drive gear and the scissors gear are mated with each other. By means of the elastic force of the coil springs, the primary drive gear and the scissors gear are pressed in opposite rotational directions such that each tooth of the primary driven gear is sandwiched between and held by corresponding teeth of the primary drive gear and the scissors gear.

### PRIOR ART DOCUMENTS

### Patent Documents

Patent Document 1: Japanese Patent Application Laid-Open (kokai) No. 2002-295523

Patent Document 2: Japanese Patent Application Laid-Open (kokai) No. H08-093886

However, in the case of the scissors gear devices disclosed in Patent Documents 1 and 2, a space for providing a torsion spring or coil springs must be secured on the radially inner side of the bottoms of tooth grooves of the sub-gear or the scissors gear. Therefore, the conventional scissors gear devices have a problem in that the diameter of the sub-gear or the scissors gear increases, which limits the range of application of the scissors gear devices.

Also, the scissors gear devices disclosed in Patent Documents 1 and 2 have a large number of components, such as a component for holding the sub-gear or the torsion spring, a component for preventing rotation of the torsion spring, and the three coil springs. Therefore, the conventional scissors gear devices have a problem in that the scissors gear devices become large and complex, which makes the process of assembling them complicated.

The present invention was accomplished in order to solve the above-described problems, and its object is to provide a scissors gear device having a structure which is simplified so as to reduce its overall size, to thereby expand the range of application and simplify its assembly process.

### SUMMARY OF THE INVENTION

In order to achieve the above-described object, the invention of claim 1 provides a scissors gear device which comprises a main gear; a sub-gear disposed adjacent to the main gear so as to be coaxial with the main gear and so as to be rotatable; and scissors load application means for applying a load for rotating the main gear and the sub-gear in opposite directions to thereby produce a phase difference between the two gears, wherein the scissors load application means includes a curved-surface protrusion which is provided on one of the facing surfaces of the main gear and the sub-gear facing each other and which projects toward the other facing surface; a sloped surface which is provided on the other facing surface such that the sloped surface is recessed from the other facing surface and which slides on the curved-surface protrusion; and pressing means for pressing at least one of the main gear and the sub-gear toward the other of the main gear and the sub-gear.

According to the feature of the invention of claim 1, the scissors gear device is configured such that a curved-surface protrusion and a sloped surface which slide relative to each other are provided on the facing surfaces of the main gear and the sub-gear which face each other, and pressing means for pressing one of the sub-gear and the main gear against the other of the sub-gear and the main gear is provided. Therefore, in the scissors gear device, as a result of relative sliding displacement of the curved-surface protrusion and the sloped surface, the main gear and the sub-gear rotate in opposite directions. The scissors gear device is mainly composed of the main gear having one of the curved-surface protrusion and the sloped surface, the sub-gear having the other of the curved-surface protrusion and the sloped surface, and the pressing means. Therefore, the scissors gear device has a simplified structure compared with conventional devices. Thus, it is possible to reduce the size of the entire device to thereby expand the range of application. It is also possible to simplify a process of assembling the device. Furthermore, in the scissors gear device, theoretically the curved-surface protrusion is in point or line contact with the sloped surface. Therefore, sliding resistance can be decreased, and the main gear and the sub-gear can be moved smoothly relative to each other. In addition, a hitting sound produced as a result of hitting of the curved-surface protrusion against the sloped surface can be decreased to a lower level. Another feature of the present invention recited in claim 2 is that the main gear and the sub-gear are formed of a metallic material, and the sloped surface has a slope angle of 30° or less with respect to a plane orthogonal to the rotational axis of the main gear and the sub-gear.

According to the feature of the invention of claim 2, the main gear and the sub-gear of the scissors gear device are formed of a metallic material, and the sloped surface has a slope angle of 30° or less with respect to a plane orthogonal to the rotational axis of the main gear and the sub-gear. Namely, in the scissors gear device, since the sloped surface has a relatively small slope angle of 30° or less, the amount by which the meshed gears slide in the axial direction relative to each other can be reduced. As a result, it is possible to reduce a beating sound due to vibration and a hitting sound produced when the curved-surface protrusion and the sloped surface hit against each other.

Another feature of the present invention recited in claim 3 is that three sets each including the curved-surface protrusion and the sloped surface are provided on the facing surfaces of the main gear and the sub-gear, and two of three intervals between the three sets differ from each other.

According to the feature of the invention of claim 3, three sets each including the curved-surface protrusion and the sloped surface are provided on the facing surfaces of the main gear and the sub-gear, and two of three intervals between the three sets differ from each other. In other words, in the scissors gear device, the three sets each including the curved-surface protrusion and the sloped surface are not evenly disposed on the facing surfaces of the main gear and the sub-gear. Therefore, the scissors gear device can prevent so-called erroneous assembly in which the main gear and the sub-gear are assembled such that the teeth of the main gear have an erroneous positional relation with the teeth of the sub-gear. Also, in the case where the number of teeth of the main gear and the number of teeth of the sub-gear are not a multiple of 3, the scissors gear device can prevent a decrease in strength of the gears, which decrease would otherwise occur as a result of the curved-surface protrusions and the sloped surfaces being disposed adjacent to the bottoms of tooth spaces.

Another feature of the present invention recited in claim 4 is that the sloped surface is formed on the facing surface of the main gear or the sub-gear at a position which is located on the root side of a tooth between the bottoms of tooth spaces adjacent to each other.

According to the feature of the invention of claim 4, in the scissors gear device, the sloped surface is formed on the facing surface of the main gear or the sub-gear at a position which is located on the root side of a tooth between the bottoms of tooth spaces adjacent to each other. Therefore, a decrease in the strength of the main gear or the sub-gear can be minimized, and a thickness around the sloped surface can be secured more easily. Thus, the size of the main gear or the sub-gear can be reduced further.

### BRIEF DESCRIPTION OF THE DRAWINGS

FIG. 1 is an exploded perspective view showing the exterior of a scissors gear device according to the present invention.

FIG. 2 is a plan view of a drive shaft on which a main gear of the scissors gear device shown in FIG. 1 is formed.

FIG. 3 is a main-portion cross-sectional view showing a cross section of a main portion of the scissors gear device taken along line A-A shown in FIG. 2.

FIG. 4 is an enlarged partial front view showing, on an enlarged scale, a curved-surface protrusion and a sloped surface as viewed from the direction of arrow B shown in FIG. 2.

FIG. 5 is an enlarged partial front view showing, on an enlarged scale, a curved-surface protrusion and a sloped surface according to a modification of the present invention.

### MODE FOR CARRYING OUT THE INVENTION

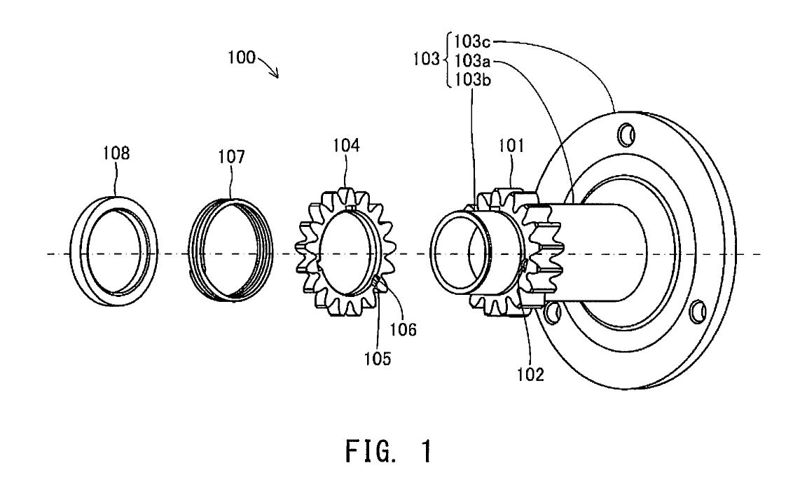

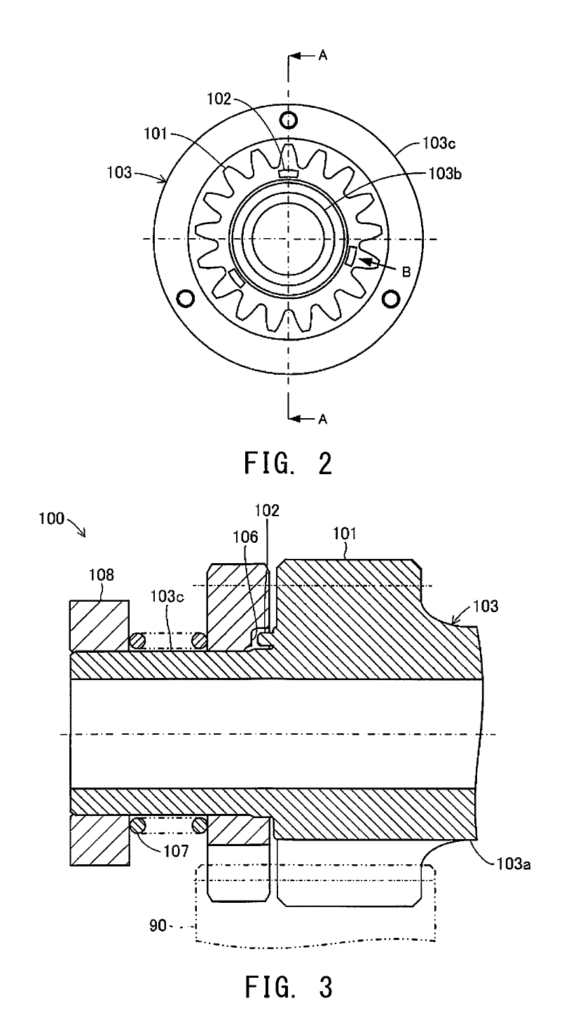

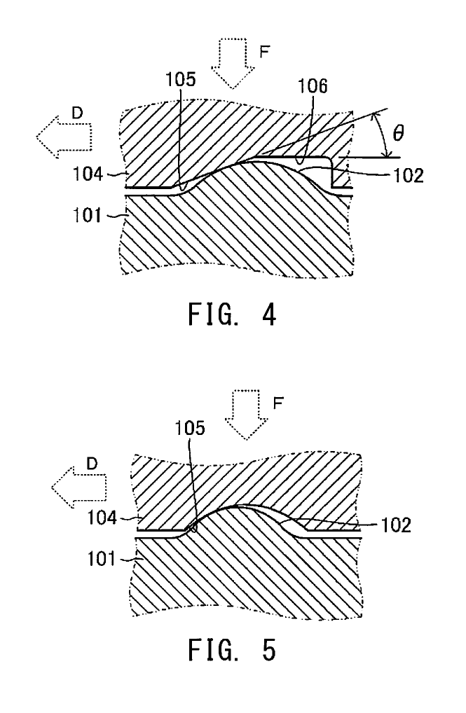

One embodiment of a scissors gear device according to the present invention will now be described with reference to the drawings. FIG. 1 is an exploded perspective view showing the structure of a scissors gear device 100 according to the present invention. FIG. 2 is a plan view of a drive shaft 103 on which a main gear 101 of the scissors gear device 100 shown in FIG. 1 is formed. FIG. 3 is a main-portion cross-sectional view showing a cross section of a main portion of the scissors gear device 100 taken along line A-A shown in FIG. 2. FIG. 4 is an enlarged partial front view showing, on an enlarged scale, a curved-surface protrusion 102 and a sloped surface 105 as viewed from the direction of arrow B shown in FIG. 2. In each of the drawings which will be referred to herein, some components are shown schematically, such as in an exaggerated manner so as to facilitate the understanding of the present invention. Therefore, the dimensions, dimensional ratios, etc. of the constituent elements may differ from the actual dimensions, dimensional ratios, etc. The scissors gear device 100 is used as a gear which transmits power in an unillustrated clutch apparatus mounted on an unillustrated automobile, motorcycle, or the like.

### Structure of the Scissors Gear Device 100

The scissors gear device 100 has the above-mentioned main gear 101. The main gear 101 is a steel spur gear which is meshed with a drive gear 90 which transmits rotational drive power to the scissors gear device 100 or receives rotational drive power from the scissors gear device 100. The main gear 101 has a large number of teeth radially projecting from the outer circumferential surface of the drive shaft 103. The main gear 101 has three curved-surface protrusions 102 formed on one side surface thereof (on the left-hand side in FIG. 3). The curved-surface protrusions 102 are arranged in the circumferential direction along a peripheral edge of the side surface.

Each curved-surface protrusion 102 produces relative movement of a sub-gear 104 to be described later in the axial and circumferential directions. Each curved-surface protrusion 102 is formed on the side surface of the main gear 101 such that the curved-surface protrusion 102 protrudes and forms an arcuate shape as viewed in the circumferential direction. In the present embodiment, each curved-surface protrusion 102 is defined by an arcuate convex surface having a radius of about 2 mm, a projection amount of about 1 mm, an overall length of about 3.5 mm, and a width (in the radial direction) of about 1 mm. The three curved-surface protrusions 102 are disposed, in a dispersed manner, on the side surface of the main gear 101 such that two of the three intervals between the curved-surface protrusions 102 differ from each other. Each curved-surface protrusion 102 is formed at a position on the root side of a tooth which is located between the bottoms of the tooth spaces adjacent to the tooth. The curved-surface protrusions 102 are formed on the side surface of the main gear 101 by means of forging.

The drive shaft 103 is a steel shaft which transfers rotational drive power to the main gear 101 or receives rotational drive power from the main gear 101 and which has a cylindrical tubular shape. The drive shaft 103 is mainly composed of a large diameter portion 103a, a small diameter portion 103b, and a flange 103c. The large diameter portion 103a extends rightward from the other side surface (on the right-hand side in FIG. 3) of the main gear 101 and has a cylindrical tubular shape.

The smaller diameter portion 103b extends leftward from the one side surface (on the left-hand side in FIG. 3) of the main gear 101, has a cylindrical tubular shape, and has a diameter smaller than that of the large diameter portion 103a. The small diameter portion 103b supports the sub-gear 104, a spring, and a collar. The flange 103c is used to connect the scissors gear device 100 to an unillustrated component of the clutch apparatus. The flange 103c extends radially outward from one end of the large diameter portion 103a (located on the right-hand side in FIG. 1).

The sub-gear 104 is a steel spur gear which is meshed with the drive gear 90, like the main gear 101, in a state in which it is disposed coaxially with and adjacent to the main gear 101. The sub-gear 104 has a large number of teeth radially projecting from the outer circumferential surface of its cylindrical body. The teeth of the sub-gear 104 are formed such that they have the same diameter and module as those of the main gear 101, and the tooth width is smaller than that of the main gear 101. The inner diameter of the sub-gear 104 is made larger than the outer diameter of the small diameter portion 103b of the drive shaft 103 so that a predetermined gap for loose fitting is formed between the sub-gear 104 and the small diameter portion 103b. Namely, the sub-gear 104 is slidably fit onto the small diameter portion 103b of the drive shaft 103.

The sub-gear 104 has three sloped surfaces 105 formed on a side surface which faces the main gear 101. The sloped surfaces 105 are arranged in the circumferential direction along a peripheral edge of the side surface. The above-mentioned curved-surface protrusions 102 slide on the sloped surfaces 105 to thereby move the sub-gear 104 in the axial and circumferential directions with respect to the main gear 101. The sloped surfaces 105 are formed at positions corresponding to the curved-surface protrusions 102 formed on the side surface of the main gear 101. More specifically, each sloped surface 105 is a flat surface which is formed on the side surface of the sub-gear 104 such that it extends in the circumferential direction and slopes toward the interior of the sub-gear 104 at a predetermined angle θ. In the present embodiment, each sloped surface 105 is formed such that it has a slope angle θ of about 20° with respect to a plane parallel to the side surface of the sub-gear 104, a depth equal to the projection amount of the curved-surface protrusions 102, an overall length of about 2 mm, and a width (in the radial direction) of about 1.5 mm which is greater than the width of the curved-surface protrusions 102.

A recess 106 is formed at the deepest portion of each sloped surface 105 so as to prevent interference with the curved-surface protrusions 102. Specifically, each recess 106 extends in the circumferential direction of the sub-gear 104 while maintaining a fixed depth and has a wall which extends in a direction perpendicular to the bottom of the recess toward the side surface of the sub-gear 104. Each sloped surface 105 and each recess 106 are formed on the side surface of the sub-gear 104 by means of cutting.

On the small diameter portion 103b of the drive shaft 103 on which the sub-gear 104 is supported, a spring 107 is disposed adjacent to the sub-gear 104. The spring 107 is an elastic member which presses the sub-gear 104 in a region around the small diameter portion 103b of the drive shaft 103. The spring 107 is a coil spring made of steel. Namely, the spring 107 corresponds to the pressing means of the present invention. On the small diameter portion 103b of the drive shaft 103 on which the spring 107 is supported, a collar 108 is disposed adjacent to the spring 107. The collar 108 is a member which receives a reaction force from the spring 107 which presses the sub-gear 104 on the small diameter portion 103b of the drive shaft 103. The collar 108 is formed from a steel material and has a ring-like shape. The collar 108 is fixedly press-fit onto the small diameter portion 103b of the drive shaft 103.

### Operation of the Scissors Gear Device 100

Next, the operation of the scissors gear device 100 configured as described above will be described. As described above, the scissors gear device 100 is incorporated into an unillustrated clutch apparatus mounted on an unillustrated automobile, motorcycle, or the like, and serves as a gear for transmitting power. Specifically, the scissors gear device 100 transmits rotational power while maintaining a state in which one tooth of the drive gear 90 is sandwiched between and held by one tooth of the main gear 101 and one tooth of the sub-gear 104.

Namely, as indicated by arrow F in FIG. 4, the sub-gear 104 of the scissors gear device 100 is always pressed toward the main gear 101 side by means of the pressing force of the spring 107. Therefore, as indicated by arrow D in FIG. 4, each sloped surface 105 of the sub-gear 104 slides and moves toward the root of the corresponding curved-surface protrusion 102 of the main gear 101 (toward the left-hand side in FIG. 4) while pressing the corresponding curved-surface protrusion 102 of the main gear 101. Therefore, the sub-gear 104 rotates in the circumferential direction with respect to the main gear 101, whereby a phase difference is produced between the two gears.

In this case, the sub-gear 104 can rotate smoothly because the contact between each sloped surface 105 and the corresponding curved-surface protrusion 102 is line contact, and sliding resistance is low. As a result, the scissors gear device 100 maintains a state in which each tooth of the drive gear 90 is sandwiched between and held by corresponding teeth of the main gear 101 and the sub-gear 104 which have moved relative to each other in the rotational direction. As a result, the scissors gear device 100 can eliminate backlash which would otherwise be produced between the teeth of the main gear 101 and the teeth of the drive gear 90. Namely, the curved-surface protrusions 102, the sloped surfaces 105, and the spring 107 correspond to the scissors load application means of the present invention.

In a state in which the scissors gear device 100 is operating as described above, the rotational direction of the drive gear 90 or the main gear 101 may be reversed, or the scissors gear device 100 may receive vibration or impacts from the clutch apparatus in which the scissors gear device 100 is incorporated or the vehicle on which the clutch apparatus is mounted. In such a case, the sub-gear 104 may move in the circumferential direction and/or the axial direction against the pressing force of the spring 107, and the sloped surfaces 105 may separate from the curved-surface protrusions 102. In such a case, the sub-gear 104 is immediately pressed by the pressing force of the spring 107 in a direction for moving the sloped surfaces 105 toward the curved-surface protrusions 102. Therefore, a hitting sound may be produced as a result of hitting between the sloped surfaces 105 and the curved-surface protrusions 102. However, in the scissors gear device 100, each sloped surface 105 is in line contact with the corresponding curved-surface protrusion 102, and the slope angle θ is relatively small (20°). Therefore, the hitting sound can be suppressed to a lower level. Also, the above-mentioned low sliding resistance allows the scissors gear device 100 to immediately recover the original state in which each tooth of the drive gear 90 is sandwiched between and held by a corresponding tooth of the main gear 101 and a corresponding tooth of the sub-gear 104.

As can be understood from the above-described operation, in the scissors gear device 100 of the above-described embodiment, the curved-surface protrusions 102 and the sloped surfaces 105 which slide relative to each other are provided on the facing surfaces of the main gear 101 and the sub-gear 104 which face each other, and the spring 107 for pressing the sub-gear 104 against the main gear 101 is provided. Therefore, in the scissors gear device 100, as a result of relative sliding displacement of the curved-surface protrusions 102 and the sloped surfaces 105, the main gear 101 and the sub-gear 104 rotate in opposite directions. The scissors gear device 100 is mainly composed of the main gear 101 having the curved-surface protrusions 102, the sub-gear 104 having the sloped surfaces 105, and the spring 107. Therefore, the scissors gear device 100 has a simplified structure compared with conventional devices. Thus, it is possible to reduce the size of the entire device and thereby expand the range of application. Also, it is possible to simplify a process of assembling the device. Furthermore, in the scissors gear device 100, each curved-surface protrusion 102 is in line contact with the corresponding sloped surface 105. Therefore, sliding resistance can be decreased, and the main gear 101 and the sub-gear 104 can be moved smoothly relative to each other. In addition, the hitting sound produced as a result of hitting between the curved-surface protrusions 102 and the sloped surfaces 105 can be decreased to a lower level.

The present invention is not limited to the above-described embodiment, and it may be modified in various ways without departing from the scope of the present invention. In a drawing which shows a modification to be described below, portions identical to those of the scissors gear device 100 of the above-described embodiment are denoted by the same reference numerals, and their description will not be repeated.

In the scissors gear device 100 of the above-described embodiment, the curved-surface protrusions 102 are formed on a side surface of the main gear 101, and the sloped surfaces 105 are formed on a side surface of the sub-gear 104. However, it is sufficient for the curved-surface protrusions 102 to be formed on one of the facing surfaces of the main gear 101 and the sub-gear 102 facing each other and for the sloped surfaces 105 to be formed on the other of the facing surfaces. Namely, the scissors gear device 100 may be configured such that the sloped surfaces 105 are formed on the side surface of the main gear 101 and the curved-surface protrusions 102 are formed on the side surface of the sub-gear 104.

In the above-described embodiment, the curved-surface protrusions 102 have an arcuate bulging shape. However, the shape of the curved-surface protrusions 102 is not limited to the shape employed in the above-described embodiment, so long as the curved-surface protrusions 102 are formed at positions for contact with the sloped surfaces 105 such that each curved-surface protrusion 102 protrudes and forms a curved surface, i.e., such that each curved-surface protrusion 102 comes into point or line contact with the corresponding sloped surface 105. For example, the curved-surface protrusions 102 may be formed to have an elliptical arcuate shape or a spherical shape.

In the above-described embodiment, the sloped surfaces 105 are flat surfaces extending in a straight line. However, the shape of the sloped surfaces 105 is not limited to the shape employed in the above-described embodiment so long as the sloped surfaces 105 are formed at positions for contact with the curved-surface protrusions 102 such that they form concave shapes and come into point contact or line contact the curved-surface protrusions 102. For example, the sloped surfaces 105 may be formed to have an arcuate shape as shown in FIG. 5. In this case, the arcuate sloped surfaces 105 preferably have a diameter greater than that of the arcuate of the curved-surface protrusions 102. In this case as well, effects similar to those of the above-described embodiment are expected. Alternatively, the sloped surfaces 105 may be spherical concave surfaces.

In the above-described embodiments, the slope angle θ of the sloped surfaces 105 with respect to a plane parallel to the side surface of the sub-gear 104 is about 20°. However, the slope angle θ of the sloped surfaces 105 can be properly set in accordance with the specifications of the scissors gear device 100 and is not limited to the slope angle employed in the embodiment. In the case of a scissors gear device 100 which always receives large vibrations or impacts from a brake apparatus or a clutch apparatus mounted on an automobile, motorcycle, or the like, or in the case of a scissors gear device 100 which transmits large drive power, a large hitting sound is likely to be produced between the curved-surface protrusions 102 of the main gear 101 and the sloped surfaces 105 of the sub-gear 104 because the main gear 101 and the sub-gear 104 are formed of a metallic material. Also, in these scissors gear devices 100 for vehicles, the sub-gear 104 axially slides with respect to the drive gear 90 and produces an unavoidable beating sound or vibration due to vibration transmitted from the engine, the clutch apparatus, the brake apparatus, or the like, so-called back torque transmitted from wheels, and forming errors and assembly errors of the main gear 102 and the sub-gear 105.

By conducting an experiment, the present inventors found that the above-mentioned hitting sound and the above-mentioned beating sound and vibration can be suppressed by setting the slope angle θ of the sloped surfaces 105 (with respect to a plane orthogonal to the rotational axis of the main gear 102 and the sub-gear 105) to 30° or less. Accordingly, it is preferred that the slope angle θ of the sloped surfaces 105 with respect to a plane orthogonal to the rotational axis of the main gear 102 and the sub-gear 105 be greater than 0° but not greater than 30°.

In the above-described embodiment, the width of the teeth of the sub-gear 104 is smaller than the width of the teeth of the main gear 101. However, needless to say, the sub-gear 104 may be formed to have a tooth width equal to or greater than the tooth width of the main gear 101.

In the above-described embodiment, the pressing means constituted by the spring 107 presses the sub-gear 104 against the main gear 101. However, the structure of the pressing means is not limited to the structure employed in the above-described embodiment, so long as the pressing means is configured to press one of the main gear and the sub-gear against the other. For example, the pressing means may be configured to press the main gear 101 against the sub-gear 104 or configured to press the main gear 101 and the sub-gear 104 against each other. Also, the pressing means is not limited to the spring 107. Elastic members other than a coil spring, such as a spring washer and a rubber member, may be employed as the pressing means. Alternatively, the pressing means may be one which utilizes the attractive force or repulsive force of a magnet.

In the above-described embodiment, three sets each including a curved-surface protrusion 102 and a sloped surface 105 are disposed, in a dispersed manner, on the side surfaces of the main gear 101 and the sub-gear 104, and two of the three intervals between the three sets differ from each other. Therefore, the scissors gear device 100 can prevent so-called erroneous assembly in which the main gear 101 and the sub-gear 104 are assembled such that the teeth of the main gear 101 have an erroneous positional relation with the teeth of the sub-gear 104. Also, in the case where the number of the teeth of the main gear 101 and the number of the teeth of the sub-gear 104 are not a multiple of 3, the scissors gear device 100 can prevent a decrease in strength of the gears which decrease would otherwise occur as a result of the curved-surface protrusions 102 and the sloped surface 105 being disposed adjacent to the bottoms of tooth spaces. However, the number and positions of the curved-surface protrusions 102 and the sloped surfaces 105 are not limited to those employed in the above-described embodiment. Namely, it is sufficient to provide at least one set of the curved-surface protrusion 102 and the sloped surface 105 on the side surfaces of the main gear 101 and the sub-gear 104. Even in the case where the number of sets each including a curved-surface protrusion 102 and a sloped surface 105 is three or more, the intervals between the sets may be equal to one another.

In the above-described embodiment, each sloped surface 105 is formed in a region on the root side of a tooth of the sub-gear 104 which is located between the bottoms of tooth spaces adjacent to each other. Since this configuration makes it easier for the sub-gear 104 to have a sufficient thickness around each sloped surface 105 formed by cutting the sub-gear 104 into a concave shape, a decrease in the strength of the sub-gear 104 can be minimized, and the size of the sub-gear 104 can be reduced further. However, the positions of the sloped surfaces 105 are not limited to those employed in the above-described embodiment, and the sloped surfaces 105 may be formed at arbitrary positions on the side surface of the main gear 101 or the sub-gear 104. For example, in the case where the main gear 101 or the sub-gear 104 having the sloped surfaces 105 has a size or shape which allows the main gear 101 or the sub-gear 104 to have a sufficiently large thickness, each sloped surface 105 may be formed in a region near the bottom of a corresponding tooth space of the main gear 101 or the sub-gear 104.

In the above-described embodiment, the main gear 101 and the sub-gear 104 are formed of steel. However, the material of the main gear 101 and the sub-gear 104 may be freely chosen in accordance with the specifications of the scissors gear device 100. Accordingly, the main gear 101 and the sub-gear 104 may be formed of a resin. In the above-described embodiment, the main gear 101 is integrally formed with the drive shaft 103. However, as in the case of the sub-gear 104, the main gear 101 may be formed separately from the drive shaft 103 and fixed to the drive shaft 103.

### DESCRIPTION OF REFERENCE NUMERALS

θ . . . slope angle, 90 . . . drive gear, 100 . . . scissors gear device, 101 . . . main gear, 102 . . . curved-surface protrusion, 103 . . . drive shaft, 103a . . . large diameter portion, 103b . . . small diameter portion, 103c . . . flange, 104 . . . sub-gear, 105 . . . sloped surface, 106 . . . recess, 107 . . . spring, 108 . . . collar.

1-4. (canceled)

5. A scissors gear device comprising:
a main gear having a first lateral surface;
a sub-gear which is rotatably disposed adjacent to and coaxial with respect to the main gear and has a second lateral surface opposing the first lateral surface of the main gear; and
scissors load application means for applying a load for rotating the main gear and the sub-gear in opposite directions to produce a phase difference between the two gears, the scissors load application means comprising:
a curved-surface protrusion which is provided on one of the first and second lateral surfaces and which projects towards the other of the first and second lateral surfaces;
a sloped surface which is provided on the other of the first and second lateral surfaces and is recessed with respect to the other of the first and second lateral surfaces and slides on the curved-surface protrusion; and
pressing means for pressing at least one of the main gear and the sub-gear toward the other of the main gear and the sub-gear.

6. A scissors gear device as claimed in claim 5 wherein:
the main gear and the sub-gear are formed of a metallic material; and
the sloped surface has a slope angle of 30° or less with respect to a plane orthogonal to a rotational axis of the main gear and the sub-gear.

7. A scissors gear device as claimed in claim 5 wherein the load application means includes three curved-surface protrusions which are provided on one of the first and second lateral surfaces and which project towards the other of the first and second lateral surfaces and three sloped surfaces which are provided on the other of the first and second lateral surfaces and are recessed with respect to the other of the first and second lateral surfaces and slide on the curved-surface protrusions, each of the curved-surface protrusions defines a set with one of the sloped surfaces, and two of three intervals between the three sets differ from each other.

8. A scissors gear device as claimed in claim 5 wherein each of the main gear and the sub-gear comprises a plurality of teeth separated from adjoining teeth by a tooth space having a bottom, and the sloped surface is formed on the root side of one of the teeth of the main gear or the sub-gear between the bottoms of consecutive tooth spaces adjoining the tooth on which the sloped surface is formed.
